(19) United States
(12) Patent Application Publication
(10) Pub. No.: US 2009/0144438 A1
(43) Pub. Date: Jun. 4, 2009

(54) STANDARDS ENABLED MEDIA STREAMING

(75) Inventor: Marie Jose Montpetit, Jamaica Plain, MA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/947,898

(22) Filed: Nov. 30, 2007

(51) Int. Cl. G06F 15/16

(52) U.S. Cl. 709/230

(57) ABSTRACT

A system and method are provided for streaming media from a media device to a client device using a standards platform, as opposed to a proprietary platform. In one example, the method involves sending an invite for communication to the media device, receiving an acceptance of the invite for communication from the media device, sending a play request to the media device, and receiving an acceptance of the play request from the media device, wherein communications between the media device and the client device are handled in at least one standard protocol and are not handled in a proprietary protocol.

### FIELD OF THE INVENTION

The present invention relates to media streaming. More particularly, the present invention relates to enabling devices to stream media over the Internet using commonly available standards.

### BACKGROUND OF THE INVENTION

A typical media streaming system enables a user to watch and control the user's television from anywhere the user is located. The user can do so from virtually any Internet-connected computer, personal digital assistant (PDA), or Microsoft Windows® enabled cell phone.

FIG. 1 is a block diagram of a typical media streaming system 101 for a typical living room television. A television source 102 is connected to a set top box 104, which is connected to a television 106. The television source 102 may be an antenna, a cable, or a satellite. The set top box 104 may include a digital video recorder. The media streaming system 108 is coupled to the television source 102 via the set top box 104. The media streaming system 108 may also be connected directly to the television source 102. The media streaming system 108 is connected to a network 110, either wired or wirelessly. The network 110 may include a home network, the Internet or both. From that setup, the user can watch living room television programming from wherever the user is. The user can access the television programming from any laptop or Internet-connected computer. The user can also connect the media streaming system 108 to other audio/visual devices, such as a DVD player, a VCR, or a CD player.

Unfortunately, the media streaming system 101 and other similar technologies are generally deliberately proprietary. For the most part, these technologies do not operate within the realm of industry standards. As a result, engineers and application programmers from other companies are unable to interface with these technologies. Accordingly, engineers and application programmers cannot integrate these proprietary technologies into other products that otherwise comply with commonly accepted industry standards. Such lack of integration causes these proprietary technologies to be limited in their capabilities. Technological advances with these proprietary technologies have been unduly stilted because the proprietary technologies cannot integrate with technologies from other companies to create novel products.

### SUMMARY OF THE INVENTION

What is needed is an improved system having features for addressing the problems mentioned above and new features not yet discussed. Broadly speaking, the present invention fills these needs by providing a media streaming media enabled by a standards platform, as opposed to a proprietary platform. It should be appreciated that the present invention can be implemented in numerous ways, including as a method, a process, an apparatus, a system or a device. Inventive embodiments of the present invention are summarized below.

In one embodiment, a method is provided for streaming media from a media device to a client device. The method comprises sending an invite for communication to the media device, receiving an acceptance of the invite for communication from the media device, sending a play request to the media device, and receiving an acceptance of the play request from the media device, wherein communications between the media device and the client device are handled in at least one standard protocol and are not handled in a proprietary protocol.

In another embodiment, a client device is provided for receiving streaming media from a media device. The client device comprises a client sending device configured to send an invite for communication to the media device, and a client receiving device configured to receive an acceptance of the invite for communication, wherein the client sending device is further configured to send a play request to the media device, wherein the client receiving device is further configured to receive an acceptance of the play request from the media device, and wherein communications between the media device and the client device are handled in at least one standard protocol and are not handled in a proprietary protocol.

In still another embodiment, a media device is provided for sending streaming media to a client device, the media device comprises a media receiving device configured to receive an invite for communication from the client device, and a media sending device configured to send an acceptance of the invite for communication to the client device, wherein the media receiving device is further configured to receive a play request from the client device, wherein the media sending device is further configured to send an acceptance of the play request to the client device, and wherein communications between the media device and the client device are handled in at least one standard protocol and are not handled in a proprietary protocol.

The invention encompasses other embodiments configured as set forth above and with other features and alternatives.

### BRIEF DESCRIPTION OF THE DRAWINGS

The present invention will be readily understood by the following detailed description in conjunction with the accompanying drawings. To facilitate this description, like reference numerals designate like structural elements.

FIG. 1 (Prior Art) is a block diagram of a typical media streaming system for a typical living room television;

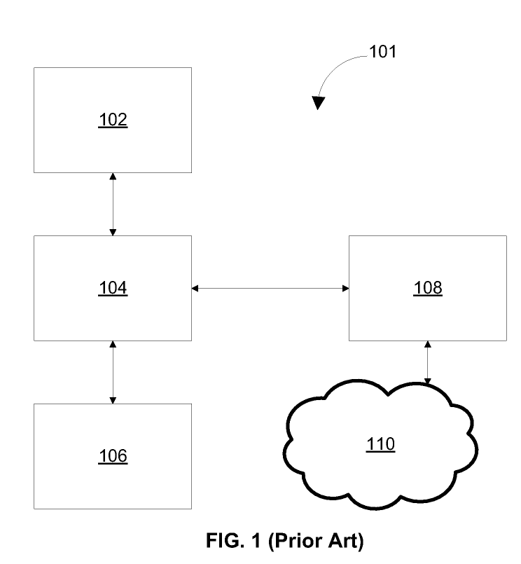

FIG. 2 is a block diagram of a media streaming system utilizing an Internet Management Subsystem (IMS), in accordance with an embodiment of the present invention;

FIG. 3 is a ping diagram of a media streaming method, in accordance with an embodiment of the present invention;

FIG. 4 is a block diagram of a media streaming system utilizing an application server, in accordance with an embodiment of the present invention; and

FIG. 5 is a flow chart of a media streaming method, in accordance with an embodiment of the present invention.

### DETAILED DESCRIPTION OF THE PREFERRED EMBODIMENT(S)

An invention for a standards enabled media streaming method is disclosed. Numerous specific details are set forth in order to provide a thorough understanding of the present invention. It will be understood, however, to one skilled in the art, that the present invention may be practiced with other specific details.

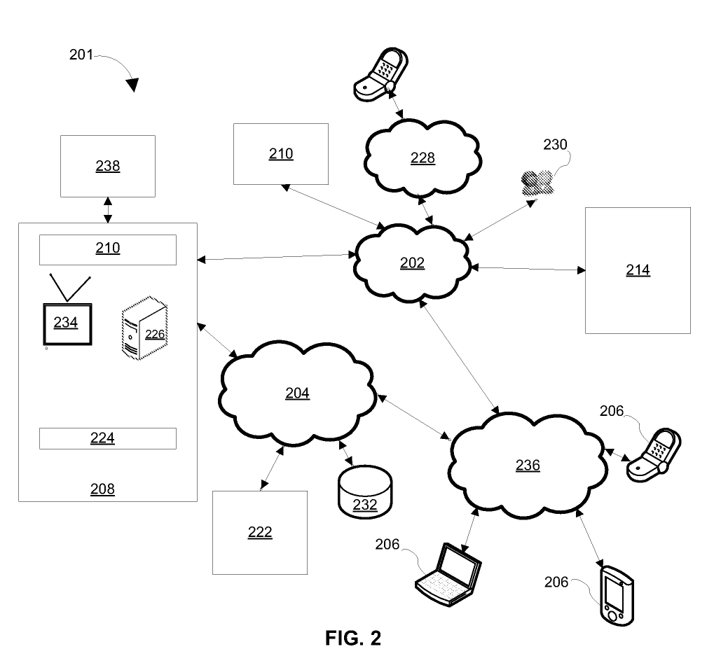

FIG. 2 is a block diagram of a media streaming system 201 utilizing an Internet Management Subsystem 202, in accordance with an embodiment of the present invention. A home media system 208 includes, among other things, a media device 210, a television 234, and a home gateway 226. The media device 210 is a DVR (digital video recorder), a set top box, or a combination thereof. The home media system 208 receives media content from a television source 238, which may be a cable or satellite feed. The home media system 208 has the capability of communicating with external devices using at least one standard protocol 224. One such standard protocol used by the home media system 208 is SIP (Session Initiated Protocol).

SIP is a standardized protocol that allows establishment of one-to-one communication between devices. SIP is an application-layer control protocol. SIP is commonly used as a signaling protocol for internet telephony or VoIP (Voice-Over-Internet Protocol). SIP can establish sessions for features such as audio/videoconferencing, interactive gaming, and call forwarding to be deployed over IP (Internet Protocol) networks, thus enabling service providers to integrate basic IP telephony services with Web, e-mail, and chat services. In addition to user authentication, redirect and registration services, SIP supports traditional telephony features such as personal mobility, time-of-day routing and call forwarding based on the geographical location of the person being called. The present invention uses a subset of SIP to provide a standardized signaling protocol for media streaming.

The home media system 208 is coupled to the Internet via an IP bearer 204. The IP bearer 204 is coupled to a remote location 216. The client device 206 accesses the Internet through an Internet connection at the remote location 216. The client device 206 may be, among other things, a cell phone, a personal digital assistant, a personal computer, or another set top box. The IP bearer may also be coupled to a video subnetwork 222 and an NDVR (network digital video recorder) 232.

In this embodiment, the home media system 208 is coupled to IMS (Internet Multimedia Subsystem) 202, which is coupled to a multimedia subsystem 212, a cellular infrastructure 228, a management subsystem 214 and presence customization 230. IMS is an IP multimedia and telephony core network that is defined by 3GPP and 3GPP2 standards and organizations based on IETF (Internet Engineering Task Force) Internet protocols. IMS is access independent as it supports IP to IP session over wireline IP, 802.11, 802.15, CDMA (Code Division Multiple Access), packet data along with GSM/EDGE/UMTS (Global System for Mobile Communications/Enhanced Data GSM Environment/Universal Mobile Telecommunications System) and other packet data applications. IMS is a standardized reference architecture that consists of session control, connection control and an applications services framework along with subscriber and services data. Accordingly, IMS provides standard management capabilities, including registrations to find who people are, find out what the people are, find out what their devices are, serve as discovery, verify subscriber bills are paid, and allow the devices to move across networks, among other things. SIP is the control plane for IMS.

IMS is commonly accepted as a central part of a control network, such as PacketCable™ 2.0. PacketCable™ is a CableLabs®-led project that was initiated by cable operators in order to define a common platform that may be used to deliver advanced real-time multimedia services over two-way cable plant. Built on top of the industry's DOCSIS® 1.1 (Data Over Cable Service Interface Specifications) cable modem infrastructure, PacketCable™ networks use IP (Internet Protocol) technology as the basis for a highly capable multimedia architecture. A DOCSIS® network with PacketCable™ extensions enables cable operators to deliver data and voice traffic efficiently and economically using a single high-speed, QoS (quality-of-service)-enabled broadband architecture. PacketCable™ 2.0 is a new PacketCable™ specification development effort that will further extend cable's IP network architecture with the goal of accelerating the convergence of voice, data, video, and mobility services. PacketCable™ 2.0 will define a modular architecture by specifying communication interfaces that enable service and feature interoperability.

The media streaming system 201 is built upon a standards-based platform. Accordingly, the media streaming system includes standardized application programming interfaces (APIs). As opposed to proprietary non-standard platforms, the standards-based platform of the present invention is flexible and expands the scope of technologies that may be developed thereupon. For example, conventional cell phones and set top boxes commonly utilize Linux®-Java® during communications with other devices. The standardized APIs of the media streaming system 201 allow application programmers to develop products upon these standards-based platforms using standard languages, such as Linux®-Java®.

The media streaming system 201, among other things, allows content on a user's home media system 208 to be watched on any other device that has access to the IP bearer 204 or the home gateway 226. This other device (ie, client device 206) may be a personal computer, a personal digital assistant, a cell phone, or another set top box, among other devices. These devices have SIP signaling stacks and can thereby establish communication with the media device 210 in the home media system 208.

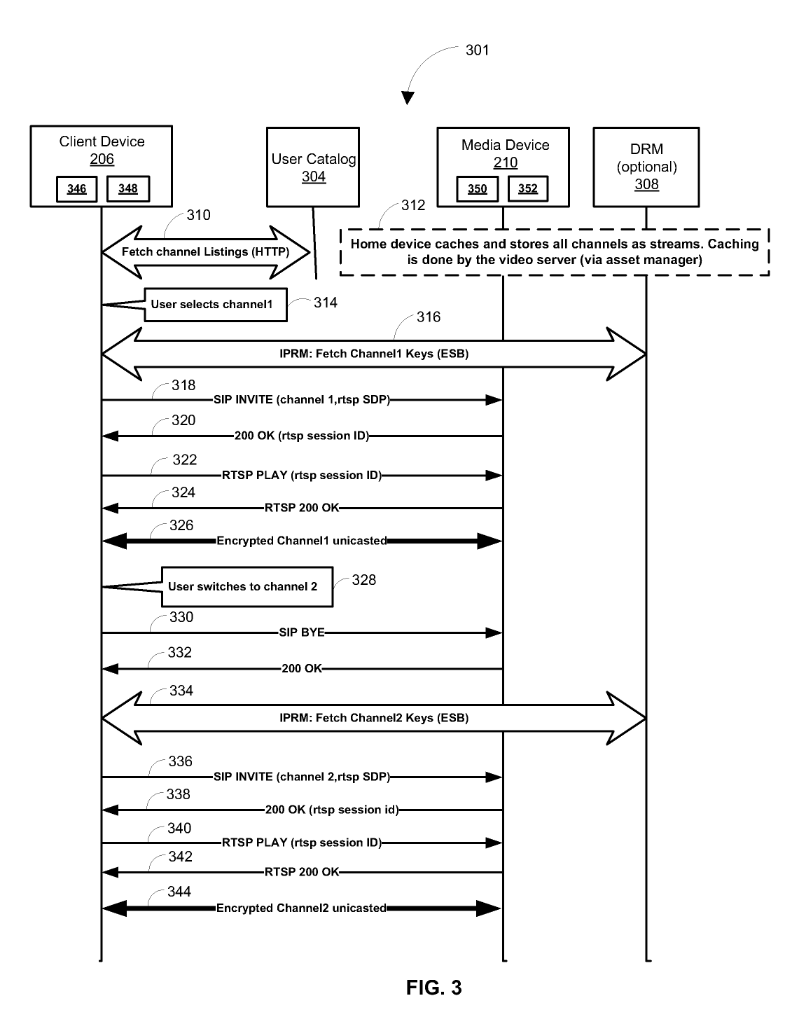

FIG. 3 is a ping diagram of a media streaming method 301, in accordance with an embodiment of the present invention. This media streaming method 301 is an example of an SIP enabled device (e.g., the client device 206) that seeks to establish communication with a home DVR or set top box (e.g., the media device 210) and get content. Note that the content may be recorded on the DVR or may be a live feed from the television source 238 coming through the set top box.

The client device 206 includes a client sending device 346 and a client receiving device 348. The client sending device 346 handles the sending of transmission to an external device, such as the media device 210. The client receiving device 348 handles the receiving of transmissions from an external device, such as the media device 210. The client sending device 346 and the client receiving device 348 are software, hardware or a combination thereof.

The media device 210 includes a media sending device 350 and a media receiving device 352. The media sending device 350 handles the sending of transmission to an external device, such as the client device 206. The media receiving device 352 handles the receiving of transmissions from an external device, such as the client device 206. The media sending device 350 and the media receiving device 352 are software, hardware or a combination thereof.

In step 310, the client device 206 fetches channel listings from a user catalog 304 using Hypertext Transfer Protocol (HTTP). The channel listings include a listing of available channels on the media device 210. In step 314, the user selects an available channel from the channel listings. In this example, the user selects Channel 1.

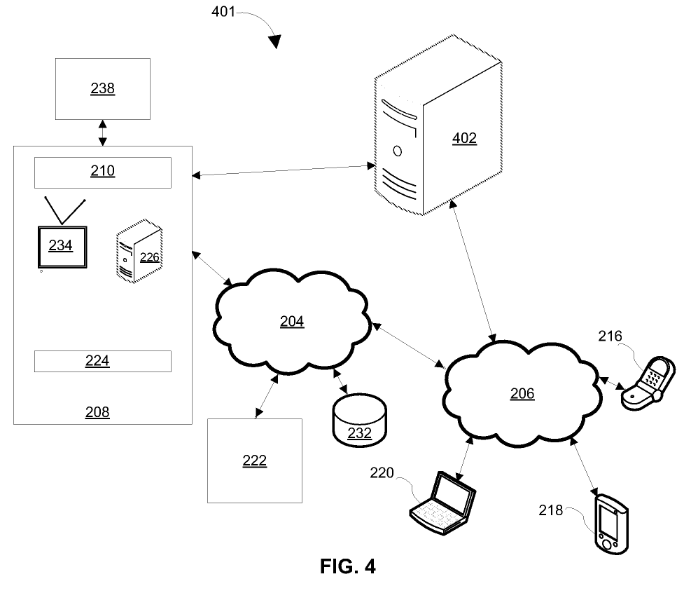

Step 316 is an optional step of Internet Protocol Rights Management (IPRM). The client device 206 fetches channel keys from a digital rights management (DRM) system 308. In this example, Channel 1 keys are fetched. The DRM system 308 is an IMS 202 or an application server 402. This fetching is carried out over an enterprise service bus (ESB). The SIP registrar and the SIP discovery handled by IMS can alternatively be handled by a single application server, which is discussed further with reference to FIG. 4. While the client device 206 is communicating with the media device 210, the media streaming method 301 does not use IMS. If there were an IMS core while the client device 206 is communicating with the media device 210, SIP signaling would likely be confused with IMS signaling.

ESB is an open standards-based distributed synchronous or asynchronous messaging middleware that provides secure interoperability between enterprise applications via XML, Web services interfaces and standardized rules-based routing of documents. In practice, this means that data files are passed to and from their destinations based on pre-established guidelines that are common to all parties sharing the information to ensure that the data maintains its integrity as it is routed. The multi-language and multi-platform design of an ESB allows enterprises to process data between applications from various sources. Two common distributed computing architectures used by ESBs are J2EE and .NET. ESB is an extension of EAI, an earlier form of middleware, but ESB adds several key functions, including transformation (the ability to transform XML documents from one data format into another so that the receiving party can interface with the data in an application format that is different from the one in which it is sent), portability (the ability to share the data between different computer systems and operating environments), load balancing/clustering (the ability to distribute processing among several devices so that no one device becomes overloaded) and failover (the ability to transfer messaging functions to another server if one should fail during the data exchange).

In step 318, the client device 206 then sends an invite request to the media device 210 using SIP. This invite includes RTSP (Real Time Transport Protocol) and a SDP (Session Description Protocol). RTSP is a standard for controlling streaming data over the Internet. RTSP, like H.323, uses RTP (Real-Time Transport Protocol) to format packets of multimedia content. However, whereas H.323 is designed for videoconferencing of moderately-sized groups, RTSP is designed to efficiently broadcast audio-visual data to large groups. SDP is a protocol that defines a text-based format for describing streaming media sessions and multicast transmissions. SDP is not a transport protocol but a method of describing the details of the transmission. For example, an SDP file contains information about the format, timing and authorship of the transmission, name and purpose of the session, any media, protocols or codec formats, the version number, contact information and broadcast times.

The media device 210 receives the SIP invite request from the client device 206. If the media device 210 accepts the SIP invite request, in step 320, the media device 210 sends back an invite acceptance to the client device 206. In this example, the invite acceptance is a “200 OK”. The invite acceptance includes an RTSP session identification. The client device 206 receives this invite acceptance from the media device 210. In step 322, the client device 206 then sends an RTSP play request to the media device 210. The play request includes an RTSP session identification. If the media device 210 accepts the RTSP play request, in step 324, the media device 210 sends back a play acceptance to the client device 206. In this example, the play acceptance is a “200 OK”. The client device 206 receives the play acceptance from the media device 210. In step 326, the unicast media streaming involves the client device 206 accessing a reference to the media stream on the media device 210. In this example, Channel 1 is encrypted and unicasted from the media device 210 to the client device 206. During this unicast, the client device 206 may send back commands to the media device 210 to control the unicast. Such commands may include, among other things, stop, pause, fast forward and rewind.

In step 328, the user decides to switch to Channel 2. In step 330, the client device 206 then sends an SIP bye request to the media device 210. If the media device accepts the by request, in step 332, the media device 210 sends back a bye request acceptance to the client device 206. In this example, the bye request acceptance is a “200 OK”.

Step 334 is an optional step of Internet Protocol Rights Management (IPRM). The client device 206 fetches channel keys from the digital rights management (DRM) system 308. In this example, Channel 2 keys are fetched. The DRM system 308 is an IMS 202 or an application server 402. This fetching is carried out over an enterprise service bus (ESB).

In step 336, the client device 206 then sends an invite request to the media device 210 using SIP. This invite includes RTSP and SDP. The media device 210 receives the SIP invite request from the client device 206. If the media device 210 accepts the SIP invite request, in step 338, the media device 210 sends back an invite acceptance to the client device 206. In this example, the invite acceptance is a “200 OK”. The invite acceptance includes an RTSP session identification. The client device 206 receives this invite acceptance from the media device 210. In step 340, the client device 206 then sends an RTSP play request to the media device 210. The play request includes an RTSP session identification. If the media device 210 accepts the RTSP play request, in step 342, the media device 210 sends back a play acceptance to the client device 206. In this example, the play acceptance is a “200 OK”. In step 344, the unicast media streaming involves the client device 206 accessing a reference to the media stream on the media device 210. In this example, Channel 2 is encrypted and unicasted from the media device 210 to the client device 206. During this unicast, the client device 206 may send back commands to the media device 210 to control the unicast. Such commands may include, among other things, stop, pause, fast forward and rewind.

FIG. 4 is a block diagram 401 of a media streaming system 201 utilizing an application server 402, in accordance with an embodiment of the present invention. In this embodiment, the home media system 208 is coupled to an application server 402, which is coupled to a client device 206 at the remote location. The application server 402 effectively takes the functionality of IMS 202 and puts that functionality into a single device, the application server 402. In other words, the application server 402 replaces the IMS core, which acts as an SIP registrar and an SIP discovery device. A network operator, such as Verizon® or Comcast®, controls the application server 402. The application server 402 is used for many other things besides the establishment of the SIP communication between the client device 206 and the media device 210.

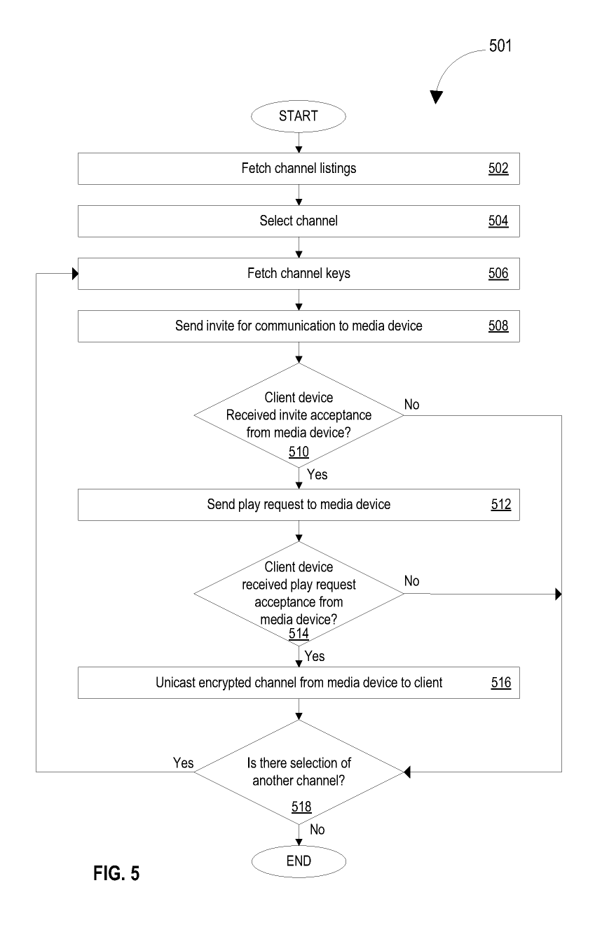

FIG. 5 is a flow chart 501 of a media streaming method 501, in accordance with an embodiment of the present invention. The media streaming method 501 starts in step 502 where the client device fetches channel listings from a user catalog. The channel listings include a listing of available channels on the media device. In step 504, the user selects an available channel from the channel listings. Step 506 is an optional step of fetching channel keys from a digital rights management (DRM) system. The DRM system is an IMS or an application server. This fetching is carried out over an enterprise service bus (ESB).

In step 508, the client device then sends an invite request to the media device using SIP. This invite includes Real Time Transport Protocol (RTSP) and a Session Description Protocol (SDP). The media device receives this SIP invite request from the client device. If the media device accepts the SIP invite request, the media device sends back an invite acceptance to the client device. The invite includes an RTSP session identification.

In decision operation 510, if the client device does not receive the invite acceptance, the method proceeds to decision operation 518 where it is determined whether there is selection of another channel. On the other hand, in decision operation 510, if the client device receives the invite acceptance, the media streaming method 501 proceeds to step 512. The client device, in step 512, sends an RTSP play request to the media device. The play request includes an RTSP session identification. If the media device accepts the RTSP play request, the media device sends back a play acceptance to the client device.

In decision operation 514, if the client device does not receive the play acceptance from the media device, the method proceeds to decision operation 518 where it is determined whether there is selection of another channel. On the other hand, in decision operation 514, if the client device receives the play acceptance from the media device, the media streaming method 501 proceeds to step 516. The unicast media streaming, in step 516, proceeds between the client device and the media device. The selected channel is encrypted and unicasted from the media device to the client device. During this unicast, the client device may send back commands to the media device to control the unicast. Such commands may include, among other things, stop, pause, fast forward and rewind.

In decision operation 518, it is determined whether the user has selected another channel. If there is selection of another channel, the media streaming method 501 proceeds again to the optional step 506 of fetching channel keys from the digital rights (DRM) system. The media streaming method 501 continues as discussed above. On the other hand, if the user has not selected another channel, the media streaming method 501 is at an end.

Portions of the present invention may be conveniently implemented using a conventional general purpose or a specialized digital computer or microprocessor programmed according to the teachings of the present disclosure, as will be apparent to those skilled in the computer art.

Appropriate software coding can readily be prepared by skilled programmers based on the teachings of the present disclosure, as will be apparent to those skilled in the software art. The invention may also be implemented by the preparation of application specific integrated circuits or by interconnecting an appropriate network of conventional component circuits, as will be readily apparent to those skilled in the art.

The present invention includes a computer program product which is a storage medium (media) having instructions stored thereon/in which can be used to control, or cause, a computer to perform any of the processes of the present invention. The storage medium can include, but is not limited to, any type of disk including floppy disks, mini disks (MD's), optical disks, DVD, CD-ROMS, micro-drive, and magneto-optical disks, ROMs, RAMs, EPROMs, EEPROMs, DRAMs, VRAMs, flash memory devices (including flash cards), magnetic or optical cards, nanosystems (including molecular memory ICs), RAID devices, remote data storage/archive/warehousing, or any type of media or device suitable for storing instructions and/or data.

Stored on any one of the computer readable medium (media), the present invention includes software for controlling both the hardware of the general purpose/specialized computer or microprocessor, and for enabling the computer or microprocessor to interact with a human user or other mechanism utilizing the results of the present invention. Such software may include, but is not limited to, device drivers, operating systems, and user applications. Ultimately, such computer readable media further includes software for performing the present invention, as described above.

Included in the programming (software) of the general/specialized computer or microprocessor are software modules for implementing the teachings of the present invention, including but not limited to sending an invite for communication to the media device, receiving an acceptance of the invite for communication from the media device, sending a play request to the media device, and receiving an acceptance of the play request from the media device, according to processes of the present invention.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

1. A method of streaming media from a media device to a client device, the method comprising:
sending an invite for communication to the media device;
receiving an acceptance of the invite for communication from the media device;
sending a play request to the media device; and
receiving an acceptance of the play request from the media device, wherein communications between the media device and the client device are handled in at least one standard protocol and are not handled in a proprietary protocol.

2. The method of claim 1, wherein the at least one standard protocol includes Session Initiated Protocol (SIP).

3. The method of claim 1, further comprising unicasting streaming media content from the media device to the client device.

4. The method of claim 1, wherein the client device is one of a cell phone, a personal digital assistant, a personal computer and another media device.

5. The method of claim 1, wherein the media device is at least one of a digital video recorder and a set top box.

6. The method of claim 2, wherein the at least one standard protocol further includes Real Time Transport Protocol (RSTP) and Session Description Protocol (SDP).

7. The method of claim 1, further comprising fetching a channel listing from a user catalog, wherein the channel listings include a listing of available channels on the media device.

8. The method of claim 1, further comprising:
receiving a selected channel; and
fetching channel keys for the selected channel from a digital rights management (DRM) system.

9. (canceled)

10. The method of claim 8, wherein the digital rights management system is handled by an application server.

11. The method of claim 1, wherein the client device and the media device are programmable with standardized application programming interfaces using at least one standard language.

12. The method of claim 11, wherein the at least one standard language includes Linux®-Java®.

13. The method of claim 3, wherein the media content is at least one of recorded media content and live media content.

14. A client device for receiving streaming media from a media device, the client device comprising:
a client sending device configured to send an invite for communication to the media device; and
a client receiving device configured to receive an acceptance of the invite for communication, wherein the client sending device is further configured to send a play request to the media device, wherein the client receiving device is further configured to receive an acceptance of the play request from the media device, and wherein communications between the media device and the client device are handled in at least one standard protocol and are not handled in a proprietary protocol.

15. The client device of claim 14, wherein the at least one standard protocol includes Session Initiated Protocol (SIP).

16. The client device of claim 14, wherein the client receiving device is further configured to receive unicasted streaming media content from the media device.

17. The client device of claim 14, wherein the client device is one of a cell phone, a personal digital assistant, a personal computer and another media device.

18. A media device for sending streaming media to a client device, the media device comprising:
a media receiving device configured to receive an invite for communication from the client device; and
a media sending device configured to send an acceptance of the invite for communication to the client device, wherein the media receiving device is further configured to receive a play request from the client device, wherein the media sending device is further configured to send an acceptance of the play request to the client device, and wherein communications between the media device and the client device are handled in at least one standard protocol and are not handled in a proprietary protocol.

19. The media device of claim 18, wherein the at least one standard protocol includes Session Initiated Protocol (SIP).

20. The media device of claim 18, wherein the media sending device is further configured to unicast streaming media content to the client device.

21. The media device of claim 18, wherein the media device is at least one of a digital video recorder and a set top box.

22. A computer-readable medium carrying one or more instructions for streaming media from a media device to a client device, wherein the one or more instructions, when executed by one or more processors, cause the one or more processors to perform the steps of:
sending an invite for communication to the media device;
receiving an acceptance of the invite for communication from the media device;
sending a play request to the media device; and
receiving an acceptance of the play request from the media device, wherein communications between the media device and the client device are handled in at least one standard protocol and are not handled in a proprietary protocol.
